(19) United States
(12) Patent Application Publication
(10) Pub. No.: US 2016/0189861 A1
(43) Pub. Date: Jun. 30, 2016

(54) POWER TRANSMITTING COIL STRUCTURE AND WIRELESS POWER TRANSMITTING APPARATUS INCLUDING THE SAME

(71) Applicant: Samsung Electro-Mechanics Co., Ltd., Suwon-Si (KR)

(72) Inventors: Isaac NAM, Suwon-Si (KR); Jae Suk SUNG, Suwon-Si (KR); Chul Gyun PARK, Suwon-Si (KR); Ji Hoon KIM, Suwon-Si (KR); Ki Won CHANG, Suwon-Si (KR)

(73) Assignee: Samsung Electro-Mechanics Co., Ltd., Suwon-Si (KR)

(21) Appl. No.: 14/980,276

(22) Filed: Dec. 28, 2015

(30) Foreign Application Priority Data
Dec. 31, 2014 (KR) 10-2014-0194611

(51) Int. Cl. H01F 38/14; H02J 7/02; H02J 5/00

(52) U.S. Cl. CPC H01F 38/14; H02J 5/005; H02J 7/025

(57) ABSTRACT

A power transmitting coil structure and a wireless power transmitting apparatus including the same are provided. The power transmitting coil includes a first coil which is wound to have a circular or polygonal shape and at least one sub coil positioned within the first coil. A magnetic field region formed by the first coil is different from a magnetic field region formed by the at least one sub coil.

### CROSS-REFERENCE TO RELATED APPLICATION

This application claims the benefit of Korean Patent Application No. 10-2014-0194611 filed on Dec. 31, 2014, in the Korean Intellectual Property Office, the entire disclosure of which is incorporated herein by reference for all purposes.

### BACKGROUND

1. Field

The following description relates to a power transmitting coil structure and a wireless power transmitting apparatus including the same.

2. Description of Related Art

With the development of wireless technology, various functions, such as the transmission of data as well as the transmission of power, have been enabled. A type of wireless charging technology allowing for the charging of various portable apparatuses in a contactless manner has recently been prominent.

However, existing schemes for wireless power transmission technology have a number of extant limitations on smooth charging. For example, a transmitting distance may be limited, while a positional relationship between transmitting and receiving apparatuses may be restricted, in the transmission and reception of power in a wireless manner. As a result, there is a limitation in that wireless power charging may only be substantially undertaken when the wireless power receiving apparatus is located in a specific position or in a specific direction with respect the wireless power transmitting apparatus.

Meanwhile, wireless power transmission technology may be applied to various portable apparatuses. Therefore, wireless power charging technology allowing efficient charging to be performed in various environments has been in demand.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to one general aspect, a power transmitting coil includes a first coil which is wound to have a circular or polygonal shape; and at least one sub coil positioned within the first coil. A magnetic field region formed by the first coil is different from a magnetic field region formed by the at least one sub coil.

The at least one sub coil may include a first sub coil wound to have the same center as the first coil; and at least one second sub coil wound to have a different center from the first coil.

The at least one sub coil may include: a first sub coil; a second sub coil; and a third sub coil, and the first to third sub coils do not overlap one another.

The first to third sub coils may be inscribed with the first coil.

The at least one sub coil may further comprise a fourth sub coil wound to have the same center as the first coil.

The first to third sub coils may be disposed on the same plane as the first coil, and the fourth sub coil may be disposed on the first to third sub coils.

According to another general aspect, a wireless power transmitting apparatus provides power to a wireless power receiving apparatus wirelessly, the wireless power transmitting apparatus includes an inverter providing resonant power; and a resonator resonated depending on the resonant power to wirelessly provide power in a contactless manner, wherein the resonator includes a plurality of power transmitting coils having different magnetic field regions.

The plurality of power transmitting coils may include a first coil wound to have a circular or polygonal shape; and at least one sub coil positioned within the first coil.

The at least one sub coil may include a first sub coil wound to have the same center as the first coil; and at least one second sub coil wound to have a different center from the first coil.

The at least one sub coil may include a first sub coil; a second sub coil; and a third sub coil, and the first to third sub coils may not overlap one another.

The first to third sub coils may be inscribed with the first coil.

The at least one sub coil may further include a fourth sub coil wound to have the same center as the first coil.

The first to third sub coils may be disposed on the same plane as the first coil, and the fourth sub coil may be disposed on the first to third sub coils.

The plurality of power transmitting coils may include one or more first plane coils adjacent to each other on the same plane; and at least one second plane coil disposed on an upper surface or a lower surface of the first plane coil.

The one or more first plane coils may have different centers from the at least one second plane coil.

The one or more first plane coils may include first to third coils wound in a corresponding shape to one another, and the first to third coils may be disposed in symmetrical positions to one another, and the second plane coil may have a central point between first to third coils, as a central point of the second plane coil.

According to another general aspect, a wireless power transmission apparatus includes a power supply; and, a plurality of power transmitting coils coupled to the power supply, the plurality of power transmitting coils having overlapping magnetic field regions and being configured to inductively couple with a remotely situated wireless power receiving coil disposed transverse to the plurality of power transmitting coils for transmission of resonant power.

The wireless power transmission apparatus may further include a processor adaptively coupling at least one switch and the plurality of power transmitting coils, the processor configured to reconfigure an electrical connection between the power supply and the plurality of power transmitting coils.

The wireless power transmission apparatus may further include a first substrate and a second substrate disposed in stacked relation, at least one of the plurality of power transmitting coils being disposed on the second substrate.

The plurality of power transmitting coils may be adaptively reconfigured between a serial and a parallel interconnection responsive to a feedback indicative of wireless power transfer efficiency.

Other features and aspects will be apparent from the following detailed description, the drawings, and the claims.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a diagram illustrating an example in which a wireless power transmitting apparatus according to an embodiment is charged.

FIG. 2 is a perspective view illustrating coils of a wireless power transmitting apparatus and a wireless power receiving apparatus disposed perpendicularly with respect to each other.

FIGS. 3 and 4 are side views illustrating coupling of a magnetic field depending on a position of the wireless power receiving apparatus.

FIG. 5 is a diagram illustrating a power transmitting coil structure according to an embodiment.

FIG. 6 is a diagram illustrating another example power transmitting coil.

FIG. 7 is a diagram illustrating another power transmitting coil structure.

FIG. 8 is a perspective view illustrating a power transmitting coil and a power receiving coil disposed thereon.

FIG. 9 is a side view illustrating magnetic coupling of the power transmitting coil with the power receiving coil of FIG. 8.

FIG. 10 is a block diagram illustrating a wireless power transmitting apparatus.

FIG. 11 is a circuit diagram illustrating a power transmitting coil of the wireless power transmitting apparatus.

FIG. 12 is a circuit diagram illustrating a power transmitting coil of the wireless power transmitting apparatus.

FIG. 13 is a circuit diagram illustrating a power transmitting coil of the wireless power transmitting apparatus.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

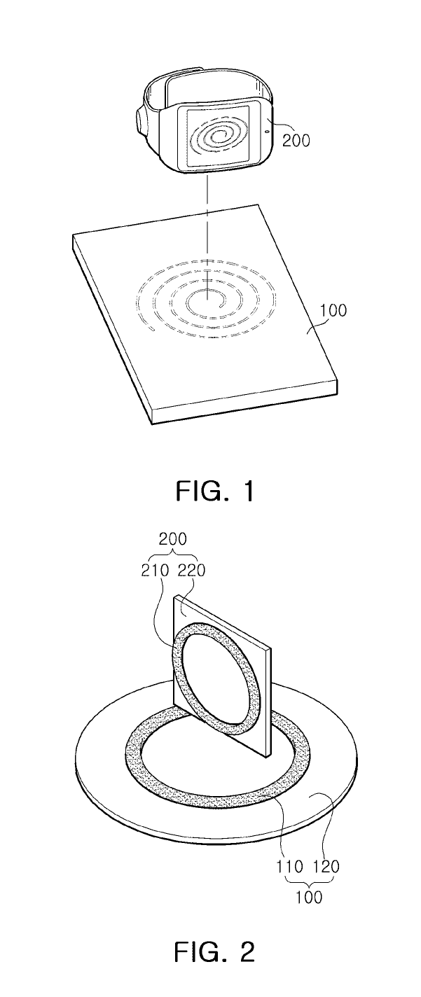

FIG. 1 is a diagram illustrating an example in which a wireless power transmitting apparatus according to an embodiment in the present disclosure is applied.

FIG. 1 illustrates a wireless power transmitting apparatus 100 and a wireless power receiving apparatus 200 disposed adjacent the wireless power transmitting apparatus 100.

The wireless power receiving apparatus 200 may receive wireless power provided by the wireless power transmitting apparatus 100 to supply power to one or more portable apparatuses. FIG. 1 illustrates a portable apparatus as a watch type wearable device, but the wireless power receiving apparatus 200 may be applied to various portable apparatuses.

The wireless power receiving apparatus 200 may be positioned at various angles and distances with respect to the wireless power transmitting apparatus 100.

Existing wireless power charging technology may smoothly perform charging only in the state in which the wireless power transmitting apparatus 100 and the wireless power receiving apparatus 200 are parallel with respect to each other. For instance, the existing wireless power charging technology may only perform charging when the coil of the wireless power transmitting apparatus 100 and the coil of the wireless power receiving apparatus 200 are parallel with respect to each other or the coil of the wireless power transmitting apparatus 100 and the coil of the wireless power receiving apparatus 200 are parallel with respect to each other.

On the other hand, the wireless power transmitting apparatus according to the embodiment in the present disclosure may smoothly perform wireless power charging even in the case in which the wireless power receiving apparatus 200 and the wireless power transmitting apparatus 100 are not parallel with each other, for example, in the case in which the wireless power receiving apparatus 200 and the wireless power transmitting apparatus 100 are provided at a 90° angle with respect to each other.

Hereinafter, various embodiments of the power transmitting coil structure and the wireless power transmitting apparatus including the same according to an embodiment will be described.

Hereinafter, the case in which the wireless power receiving apparatus 200 and the wireless power transmitting apparatus 100 are about perpendicular with respect to each other will be described as an example. However, the wireless charging may be performed even in the case in which the wireless power receiving apparatus 200 and the wireless power transmitting apparatus 100 are disposed at various angles, rather than at a perpendicular angle.

FIG. 2 is a perspective view illustrating coils of a wireless power transmitting apparatus and a wireless power receiving apparatus disposed perpendicularly with respect to each other.

The wireless power transmitting apparatus 100 may include a power transmitting coil 110. According to an embodiment, the wireless power transmitting apparatus 100 may further include a transmitting core 120. In FIG. 2 and the following drawings, a coil is illustrated as having one winding for convenience of explanation. However, the coil may be wound a plurality of times and may have a any suitable shape.

The transmitting core 120 may be formed of a substrate or a magnetic transmitting core. The magnetic transmitting core may be formed of a material having a predetermined degree of magnetism. For example, the magnetic transmitting core may be formed of a resin material including a metal powder. As another example, the magnetic transmitting core may be formed of, e.g. a ferrite sheet (including NiZnCu/MnZn-based or other ferrites), a sendust-based metal, a permalloy-based metal, an amorphous-based magnetic substance, or a combination thereof.

The wireless power receiving apparatus 200 may include a power receiving coil 210 and may further include a receiving core 220 according to the embodiment. Further, as described above, the wireless power receiving apparatus 200 may include various shapes of coil 210 and the receiving core 220 of various materials.

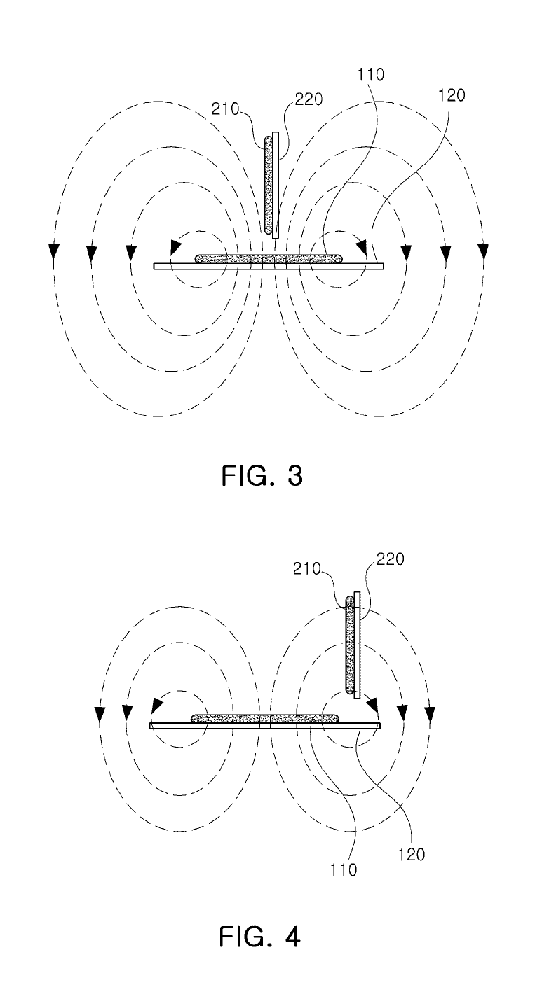

FIGS. 3 and 4 are side views illustrating coupling of a magnetic field depending on a position of the wireless power receiving apparatus according to the embodiment in the present disclosure.

FIG. 3 illustrates an example in which the coil 210 and core 220 of the wireless power receiving apparatus is positioned to correspond with a middle portion of the coil 110 of the wireless power transmitting apparatus.

The dotted lines illustrated represent a magnetic field transmitted from the coil 110 of the wireless power transmitting apparatus. The magnetic field is horizontal or slightly inclined toward the wireless power receiving apparatus 200 and therefore is only slightly magnetically coupled to the coil 210 of the wireless power receiving apparatus 200.

In contrast, FIG. 4 illustrates an example in which the coil 210 of the wireless power receiving apparatus is positioned at an edge of the core 120 of the wireless power transmitting apparatus.

As illustrated, the magnetic field transmitted from the coil 110 of the wireless power transmitting apparatus forms a loop and therefore may allow for magnetic coupling with the coil 210 of the wireless power receiving apparatus.

As illustrated in FIGS. 3 and 4, in the case of the general power transmitting coil structure, the magnetic coupling may be greatest when the coil 210 of the wireless power receiving apparatus 200 is positioned around the edge of the power transmitting coil 110.

Hereinafter, various configurations of the power transmitting coil structure 110 and the wireless power transmitting apparatus including the same according to an embodiment will be described. According to the present embodiment, the wireless power receiving apparatus 200 may receive wireless power at a high degree of efficiency even in various positions.

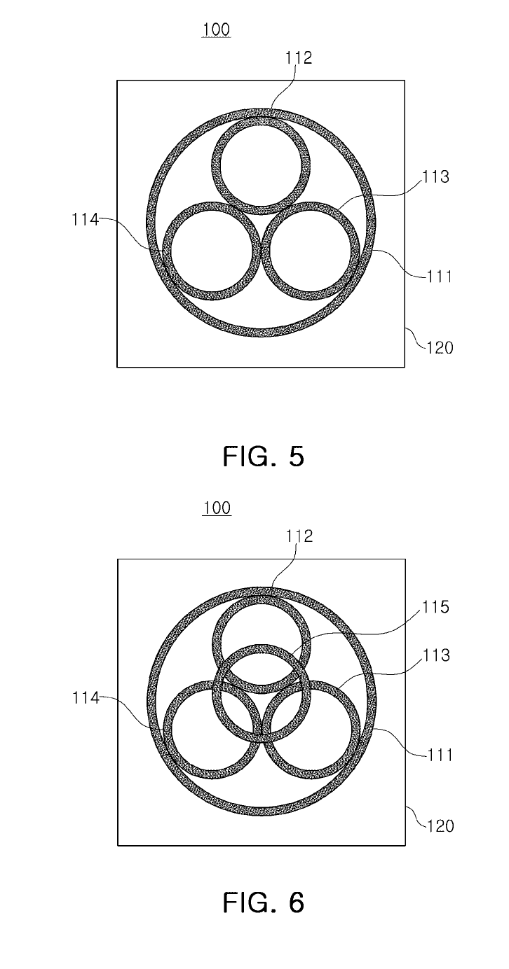

FIGS. 5 through 7 illustrate various configurations of the power transmitting coil structure. FIGS. 5 through 7 illustrate an example in which the power transmitting coil is wound in a circular form, which is exemplary. Therefore, the power transmitting coil may be wound in a polygonal shape, for example, a squared shape having rounded corners, or the like.

FIG. 5 illustrates an example of the power transmitting coil structure. According to the example configuration shown, the power transmitting coil structure 100 may include a first coil 111 and one or more sub coils 112 to 114 positioned within the first coil. The power transmitting coil structure 100 includes the transmitting core 120.

The first coil 111 may be wound to have a circular or polygonal shape. The first coil 111 has a diameter larger than that of other sub coils 112 to 114 and may include one or more sub coils 112 to 114 disposed in the circular or the polygonal shape thereof.

One or more sub coils 112 to 114 are positioned within the first coil 111. In the example illustrated, there are three sub coils 112 to 114, which is exemplary. The number of sub coils 112 to 114 is not particularly limited, but may include any suitable number.

As illustrated in FIG. 5, the first coil 111 and one or more sub coils 112 to 114 may have different central points or diameters and therefore the magnetic field regions formed by each coil may be different from each other. This is to enable the wireless power receiving apparatus 200 to easily perform the magnetic coupling even at any position of the wireless power transmitting apparatus 100.

The sub coils may include a first sub coil 112, a second sub coil 113, and a third sub coil 114. The first sub coil 112 to the third sub coil 114 do not overlap each other in this example.

The first sub coil 112 to the third sub coil 114 may be symmetrically positioned to one another. For instance, as illustrated in FIG. 5, the first sub coil 112 to the third sub coil 114 may be symmetrically positioned to one another. The first sub coil 112 to the third sub coil 114 are symmetrically positioned to one another to generate the magnetic fields symmetrically.

The first sub coil 112 to the third sub coil 114 may be inscribed with the first coil 111 as illustrated in the example shown in FIG. 5.

According to another configuration, the first sub coil 112 to the third sub coil 114 may be spaced apart from each other at an equal interval from the first coil 111.

FIG. 6 is a diagram illustrating a power transmitting coil structure according to an alternate configuration. The exemplary power transmitting coil of FIG. 6 relates to an example in which a sub coil 115 is added to the configuration of FIG. 5.

The power transmitting coil structure 100 includes the first coil 111 and one or more sub coils 112 to 115 which are positioned within the first coil 111.

Sub coils 112 to 115 include the sub coil 115 wound to have the same center as the first coil 111 and one or more sub coils 112 to 114 wound to have different centers from the first coil 111.

One or more sub coils 112 to 114 are wound to have different centers from the first coil 111 and may be formed on the same plane as the first coil 111. The sub coil 115 which is wound to have the same center as the first coil 111 may be formed on a different plane from the one or more sub coils 112 to 114.

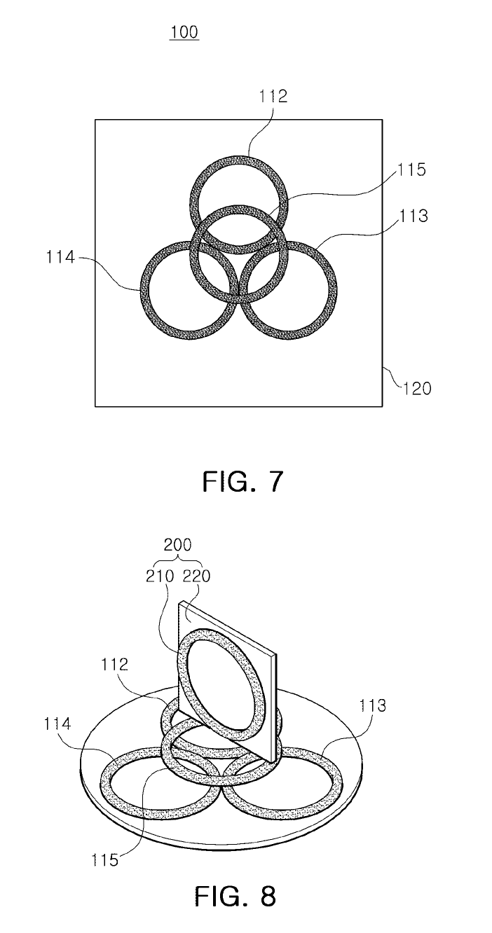

FIG. 7 is a diagram illustrating another exemplary power transmitting coil structure. FIGS. 5 and 6 illustrate examples in which the power transmitting coil structure includes the first coil 111 formed in an outermost position and the sub coils 112 to 115 having a diameter smaller than that of the first coil 111. In contrast, FIG. 7 illustrates an example in which the power transmitting coil structure does not include the first coil 111 formed at the outermost portion.

The power transmitting coil structure 100 includes one or more first plane coils 112 to 114 adjacent to one another on the same plane and at least one second plane coil 115 formed on an upper surface or a lower surface of the first plane coil. Here, the fact that the magnetic field regions formed by one or more first plane coils may be different from that formed by at least one second plane coil is as described above.

One or more first plane coils 112 to 114 may be configured to have different centers from at least one second plane coil 115.

One or more first plane coils 112 to 114 may be wound in shapes corresponding to one another and may be formed in positions symmetrical with respect to one another. For example, one or more first plane coils 112 to 114 may be wound in respective circles, each having the same diameter as illustrated in FIG. 7 and thus may be formed in positions symmetrical with respect to one another. Further, one or more first plane coils 112 to 114 may be circumscribed with one another.

At least one second plane coil 115 may have a central point between one or more first plane coils 112 to 114 symmetrically disposed with respect to one another, as a central point thereof.

Various configurations of exemplary power transmitting coil structures are described above with reference to FIGS. 5 through 7.

The above-mentioned various configurations may provide a three-dimensional magnetic field and thus the magnetic coupling may be successfully performed wherever the wireless power receiving apparatus 200 is positioned and in whatever orientation.

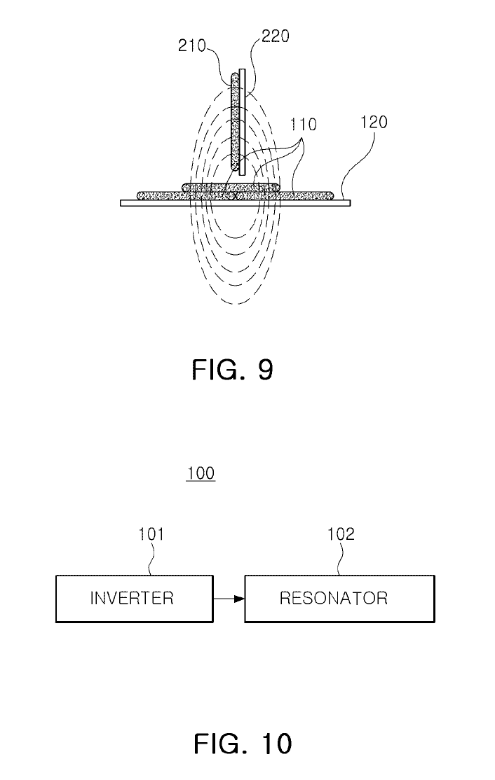

FIG. 8 is a perspective view illustrating a plurality of power transmitting coils 112 to 115 and a power receiving coil 210 disposed thereon according to the embodiment in the present disclosure and FIG. 9 is a side view illustrating the magnetic coupling of the power transmitting coils 110 with the power receiving coil 210 of FIG. 8.

The wireless power receiving apparatus 200 may be present in any position of the wireless power transmitting apparatus 100 and FIGS. 8 and 9 illustrate an example in which the wireless power receiving apparatus 200 is positioned substantially at a central portion of the wireless power transmitting apparatus 100.

As illustrated in FIG. 9, it may be appreciated that the present disclosure may achieve stable magnetic coupling, unlike the example described above with reference to FIG. 3. For instance, it may be appreciated that the collectively formed three-dimensional magnetic field may be formed by various coil structures and at least some of the three-dimensional magnetic field may be magnetically coupled to the wireless power receiving apparatus 200.

Various configurations of the power transmitting coil structure are described above. Hereinafter, the wireless power transmitting apparatus to which the foregoing power transmitting coil structure is applied will be described. Therefore, contents the same as or corresponding to those described above with reference to FIGS. 4 through 9 will not be repeatedly described below.

FIG. 10 is a block diagram illustrating a simplified example of a wireless power transmitting apparatus.

Referring to FIG. 10, the wireless power transmitting apparatus 100 includes at least an inverter 101 and a resonator 102.

The inverter 101 may provide resonant power and the resonator 102 may resonate responsive to the resonant power to provide wireless power in a contactless manner.

The resonator 102 may include an electrical storage device and a power transmitting coil, in which the power transmitting coil may have different magnetic field regions.

For instance, various configurations described above with reference to FIGS. 4 through 9 may be applied to the coil structure which may be applied to the resonator 102 and therefore the description thereof will be omitted herein for clarity and conciseness.

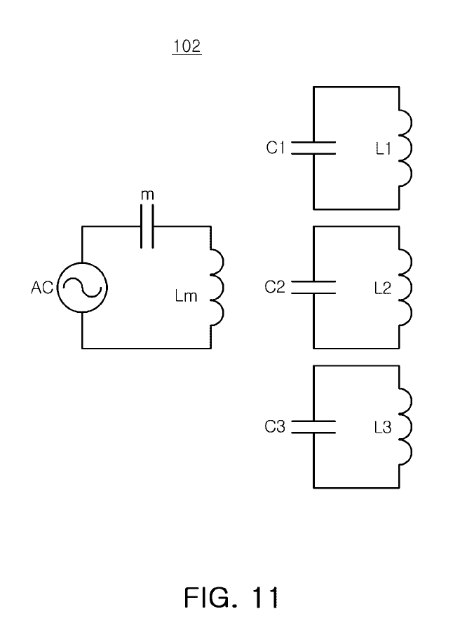

FIGS. 11 through 13 illustrate various circuit diagrams which may be applied to the resonator 102.

Referring to FIG. 11, a plurality of power transmitting coils of the resonator 102 may have separate respective power supplies. FIG. 11 illustrates a circuit diagram based on the example of FIG. 5. As illustrated in FIG. 11, an inductor Lm formed using the first coil may use a different power supply from inductors L1 to L3 formed using other sub coils. Further, the inductors L1 to L3 formed respectively using the sub coils each may also use separate power supplies (such as, for example: capacitors C1 to C3).

In this example, the power supplies may be set differently in each position of each coil, and therefore the magnetic field provided by the wireless power transmitting apparatus 100 may be precisely controlled.

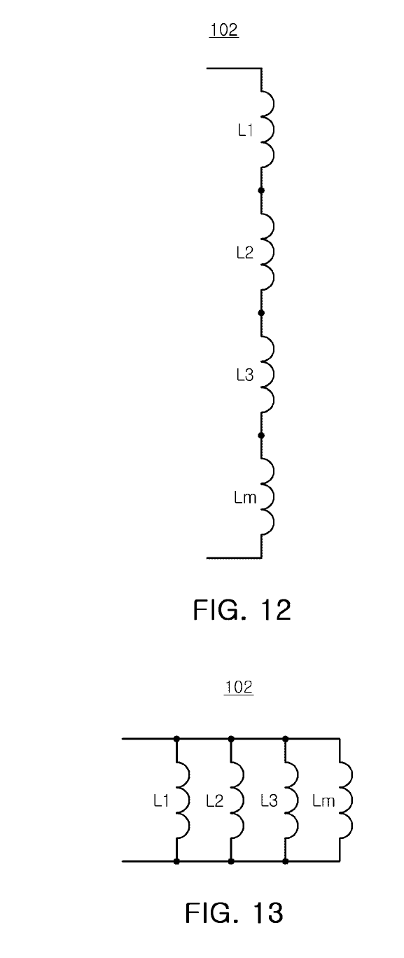

FIG. 12 illustrates an example in which the plurality of power transmitting coils of the resonator 102 are connected to each other in series and FIG. 13 illustrates an example in which the plurality of power transmitting coils of the resonator 102 are connected to each other in parallel. A processor, controller, or other logic may be coupled on opposing sides to a feedback path and a plurality of switches for adaptively reconfiguring the connection amongst the plurality of power transmitting coils responsive to the feedback. Feedback may, for example, include a reflected wave, load, resonance frequency, capacitance, impedance, or other operational parameter suitable for indicating an operational efficiency of the wireless power transmission. For example, the processor may adaptively switch between a parallel and serial connection amongst the plurality of power transmitting coils responsive to a determined efficacy of power transmission amongst at least one power receiving device. Additionally, the processor may selectively ramp up capacity or field strength by progressive use of more than one power supply to accommodate a plurality of power receiving devices.

On the other hand, the example illustrated in FIGS. 12 and 13 may use one voltage source to facilitate the configuration and the control of the circuit.

As set forth above, according to embodiments in the present disclosure, it is possible to effectively perform wireless charging irrespective of the position and the angle of the power receiving coil.

The apparatuses, units, modules, devices, and other components (e.g., the resonator 102, inverter 101, processor, switches, power receiving apparatus 200, wireless power transmitting apparatus 100, and the like illustrated in FIGS. 1-13 that perform the operations described herein are implemented by hardware components. Examples of hardware components include controllers, sensors, generators, drivers, switches, transistors, processors, and any other electronic components known to one of ordinary skill in the art. In one example, the hardware components are implemented by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods described herein that perform the operations described herein are performed by a processor or a computer as described above executing instructions or software to perform the operations described herein.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

As a non-exhaustive example only, a wireless power receiving apparatus 200 or a wireless power transmission apparatus 100 as described herein may be a mobile device, such as a cellular phone, a smart phone, a wearable smart device (such as a ring, a watch, a pair of glasses, a bracelet, an ankle bracelet, a belt, a necklace, an earring, a headband, a helmet, or a device embedded in clothing), a portable personal computer (PC) (such as a laptop, a notebook, a subnotebook, a netbook, or an ultra-mobile PC (UMPC), a tablet PC (tablet), a phablet, a personal digital assistant (PDA), a digital camera, a portable game console, an MP3 player, a portable/personal multimedia player (PMP), a head-mounted display (HMD), a handheld e-book, a global positioning system (GPS) navigation device, or a sensor, or a stationary device, such as a desktop PC, a high-definition television (HDTV), a DVD player, a Blu-ray player, a set-top box, or a home appliance, or any other mobile or stationary device capable of wireless or network communication. In one example, a wearable device is a device that is designed to be mountable directly on the body of the user, such as a pair of glasses or a bracelet. In another example, a wearable device is any device that is mounted on the body of the user using an attaching device, such as a smart phone or a tablet attached to the arm of a user using an armband, or hung around the neck of the user using a lanyard.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A power transmitting coil, comprising:
a first coil wound to have a circular or polygonal shape; and
at least one sub coil positioned within the first coil,
wherein a magnetic field region formed by the first coil is different from a magnetic field region formed by the at least one sub coil.

2. The power transmitting coil of claim 1, wherein the at least one sub coil comprises:
a first sub coil wound to have the same center as the first coil; and
at least one second sub coil wound to have a different center from the first coil.

3. The power transmitting coil of claim 1, wherein the at least one sub coil comprises:
a first sub coil;
a second sub coil; and
a third sub coil, and
the first to third sub coils do not overlap one another.

4. The power transmitting coil of claim 3, wherein the first to third sub coils are inscribed with the first coil.

5. The power transmitting coil of claim 3, wherein the at least one sub coil further comprises a fourth sub coil wound to have the same center as the first coil.

6. The power transmitting coil of claim 5, wherein the first to third sub coils are disposed on the same plane as the first coil, and
the fourth sub coil is disposed on the first to third sub coils.

7. A wireless power transmitting apparatus providing power to a wireless power receiving apparatus wirelessly, the wireless power transmitting apparatus comprising:
an inverter providing resonant power; and
a resonator resonated depending on the resonant power to wirelessly provide power in a contactless manner,
wherein the resonator includes a plurality of power transmitting coils having different magnetic field regions.

8. The wireless power transmission apparatus of claim 7, wherein the plurality of power transmitting coils comprise:
a first coil wound to have a circular or polygonal shape; and
at least one sub coil positioned within the first coil.

9. The wireless power transmission apparatus of claim 8, wherein the at least one sub coil comprises:
a first sub coil wound to have the same center as the first coil; and
at least one second sub coil wound to have a different center from the first coil.

10. The wireless power transmission apparatus of claim 8, wherein the at least one sub coil comprises:
a first sub coil;
a second sub coil; and
a third sub coil, and
the first to third sub coils do not overlap one another.

11. The wireless power transmission apparatus of claim 10, wherein the first to third sub coils are inscribed with the first coil.

12. The wireless power transmission apparatus of claim 10, wherein the at least one sub coil further comprises a fourth sub coil wound to have the same center as the first coil.

13. The wireless power transmission apparatus of claim 12, wherein the first to third sub coils are disposed on the same plane as the first coil, and
the fourth sub coil is disposed on the first to third sub coils.

14. The wireless power transmission apparatus of claim 7, wherein the plurality of power transmitting coils comprise:
one or more first plane coils adjacent to each other on the same plane; and
at least one second plane coil disposed on an upper surface or a lower surface of the first plane coil.

15. The wireless power transmission apparatus of claim 14, wherein the one or more first plane coils have different centers from the at least one second plane coil.

16. The wireless power transmission apparatus of claim 14, wherein the one or more first plane coils comprise first to third coils wound in a corresponding shape to one another, and the first to third coils are disposed in symmetrical positions to one another, and
the second plane coil has a central point between first to third coils, as a central point of the second plane coil.

17. A wireless power transmission apparatus comprising:
a power supply; and,
a plurality of power transmitting coils coupled to the power supply, the plurality of power transmitting coils having overlapping magnetic field regions and being configured to inductively couple with a remotely situated wireless power receiving coil disposed transverse to the plurality of power transmitting coils for transmission of resonant power.

18. The wireless power transmission apparatus of claim 17, further comprising a processor adaptively coupling at least one switch and the plurality of power transmitting coils, the processor configured to reconfigure an electrical connection between the power supply and the plurality of power transmitting coils.

19. The wireless power transmission apparatus of claim 17 further comprising a first substrate and a second substrate disposed in stacked relation, at least one of the plurality of power transmitting coils being disposed on the second substrate.

20. The wireless power transmission apparatus of claim 18, wherein the plurality of power transmitting coils are adaptively reconfigured between a serial and a parallel interconnection responsive to a feedback indicative of wireless power transfer efficiency.
